(19) United States
(12) Patent Application Publication
(10) Pub. No.: US 2006/0149583 A1
(43) Pub. Date: Jul. 6, 2006

(54) Method and apparatus for using software automatically and without user interaction the same way people would use such software

(76) Inventor: Clemens A. Pfeiffer, Santa Clara, CA (US)

Correspondence Address: INTERNATIONAL SOFTDEVICES CORPORATION, 2394 WALSH AVENUE, SANTA CLARA, CA, 95051, US

(21) Appl. No.: 11/269,201

(22) Filed: Nov. 8, 2005

Related U.S. Application Data
(60) Provisional application No. 60/631,110, filed on Nov. 26, 2004.

(51) Int. Cl. G06Q 99/00

(52) U.S. Cl. 705/1

(57) ABSTRACT

The present invention provides a METHOD AND APPARATUS FOR USING SOFTWARE AUTOMATICALLY AND WITHOUT USER INTERACTION THE SAME WAY PEOPLE WOULD USE SUCH SOFTWARE. This method and apparatus pertains specifically to a method and system for automating the use of software to ensure that data is entered consistently procedures are performed according to a predefined plan and schedule results are verified automatically inconsistencies are eliminated steps are executed automatic and timely an audit trail is created at each step, modification, and result Until today, only people could make the decision of the application to be selected. With the invention of Digital Employees, we are able to completely automate tasks independent of the application used for execution combining the benefits of manual tasks with batch processing in a single, dynamic, interchangeable model.

### CROSS-REFERENCE TO RELATED APPLICATIONS

This application claims the benefit of provisional patent application Ser. No. 60/631,110, filed 2004 Nov. 18 by the present inventor.

### BACKGROUND OF THE INVENTION

This invention relates to the field of using connected computers to support business transactions. Managing business transactions usually requires people to enter data, make decisions, initiate reports, verify results, and in general use Software that helps to manage the amount of data associated with today's business. For example: Each day people enter invoices, payments, and other financial transactions into enterprise resource planning systems. At end of the month, people initiate reports, verify details, and reconcile the information from a variety of sources to make sure that the information is accurate. If someone misses a detail; reports are incorrect, tax filings contain errors, and corporate compliance is at stake. In another example: Each day servers and systems stop working, people try to fix them by following predefined procedures reporting the results on paper. If the predefined procedure does not work, an experts is called in. This may be an hour later, 6 hours, 24 hours or more later.

In all these cases, people use software to perform their tasks. They use an ERP system for financial information. They use remote connectivity software to recover from problems. Common to all of it, is the fact that people use software to perform tasks. When people use free form software they skip steps. People use software to make mistakes. People use software when they miss a step. Consequently, there is a need for a method and an apparatus that reduces the load on people but performs the same tasks—automatically, without error, while using the same interfaces that a person would.

### FIELD OF THE INVENTION

This present invention relates to software.

Moreover, this invention pertains specifically to a method and system for automating the use of software to ensure that

data is entered consistently

procedures are performed according to a predefined plan and schedule

results are verified automatically

inconsistencies are eliminated

steps are executed automatic and timely

an audit trail is created at each step, modification, and result

It is desirable that such a method and system has the flexibility for adaptation to any type of existing or future software.

### DESCRIPTION OF RELATED ART

Software is usually designed to be used in either batch-mode or interactively by a user. Conventionally, batch-mode is defined as automatic execution of specific software without user interaction. Interactive usage provides a user interface for people to enter data, view results, and verify details.

While various methods and systems have been developed in the field of either batch-mode or user interactive mode interfaces, there remains a need in the art for a method and system to automate the use of both batch-mode and user interactive software by replacing people with another piece of software that simulates human abilities, hence forth in this document to be called Digital Employees. The term Digital Employees® is a Registered Trademark of International SoftDevices Corporation.

In addition, there is a need for a method and system for managing and controlling Digital Employees to perform all steps continuously and automatically according to a planned procedure and schedule. There is also a need for a method and system to monitor and assure the tasks performed by Digital Employees are in accordance to the procedures and schedule and to store and retrieve auditable data with respect to the completion of such tasks. Moreover, there is a need for a method and system for setting up rules to identify exceptions and failures when the above steps are not performed according to the planned procedure and schedule. There is also a need to log results and exceptions from tasks as done by people today.

Even though the term Digital Employee has been trademarked and used for marketing purposes by International SoftDevices Corporation since 2002, the invention outlined in this application has been made just recently due to limitations in the scope and usage of past technologies. Moreover, existing technologies, including previous versions implemented by International SoftDevices Corporation, have been unable to isolate the management of tasks from the data and application integration used in a typical software environment. As a result changes in rules, processes, tasks, resources, application and data had to be modeled as part of the process.

### SUMMARY OF THE INVENTION

In view of the limitations now present in the prior art, the present invention provides a new and useful method and an apparatus that makes use of existing software and performs tasks automatically.

The present invention comprises another piece of software—called a Digital Employee—that is able to use other software as if it were a human user, hence replacing the human user for that particular task.

Additionally Digital Employees can perform work based on a task description rather than integrated data and application specifications, example: reboot server, make payment, calculate tax, etc.

This leads to four different models in how a task can be performed:
Manual: A note is given to a person and a task is performed using a piece of software or hardware. Its up to the person to decide what to use.
Batch oriented: A task is automated in a static script using specific hardware or software.
Workflow or application based: An application tells a user to perform a task using specific hardware or software.
Using Digital Employees: A task is given to a piece of software that performs the task using a different piece of software or hardware depending on the Digital Employees predefined logic.

Using Digital Employees gives organizations the benefits of a manual model and the benefits of complete automation without the traditional compromises.

To further outline the compromises organizations have to make, FIG. 1 outlines the difference in the steps done today vs. with Digital Employees. In the “manual” model a task is given to a person and that person decides how to do it, which software to use, which hardware to use. For example to write a letter, a person can hand write it, use a typewriter, or a PC. The result is the same. The same is true for a piece of malfunctioning hardware or software. It is up to the person to decide what to do and how. In a “batch” model, everything is pre-defined and scripted. It is not done the way a person would perform the task, but rather implemented using APIs, Interfaces and lower lever application and database integration. As a result, batch mode processing is not comparable to the way a person would solve the problem. It is a static, technology driven, implementation that requires constant changes specifically with tasks that touch multiple environments. For example: Starting a complex application environment with multiple servers/applications and dependencies between them. The “application and workflow” model is even more complicated and inflexible as it links a task to an application and requires a person to use that application to perform the task. As a result it can not be used to mirror the “manual” model into a computer automated environment. The use of Digital Employees changes that model by following a different approach and structure. The attached figures (FIGS. 2, 3) show a more detailed view into the workflow and Digital Employees model.

The “workflow” model (FIG. 2) uses a process definition and initiates the tasks as required but uses two distinct models—an application client for a person and an interface for “batch” processing. As a result the workflow engine allocates the application to the task BEFORE the task is pushed to the user. Our “Digital Employees” model allocates first the resource (Digital Employee) and allows the resource to select the applications to be used to perform the task. As a result, the task has no knowledge about the application nor does it require knowing about the application, hence it mimics the “manual” model and allows replacing a person with a Digital Employee without loosing flexibility. It furthermore allows for the automation of such task with a Digital Employee without changes to the application or a direct integration of the application and the task, assembling the same model as the manual model.

Until today, only people could make the decision of the application to be selected. With the invention of Digital Employees, we are able to completely automate tasks independent of the application used for execution.

### BRIEF DESCRIPTION OF THE DRAWINGS

The drawings (FIGS. 1, 2 and 3) further outline the details:

FIG. 1 shows 4 ways how tasks are performed. From the left to the right they are:

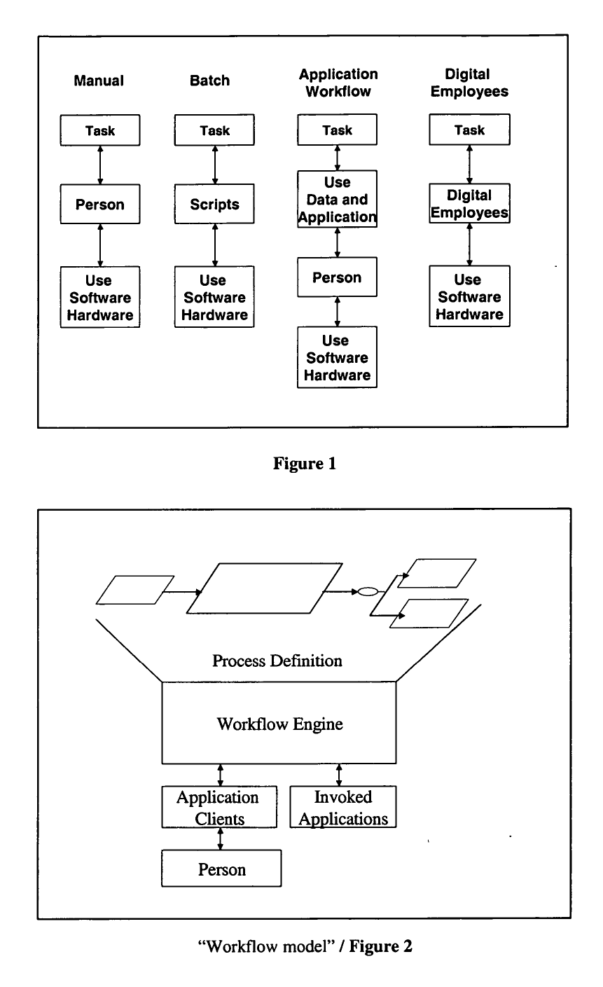

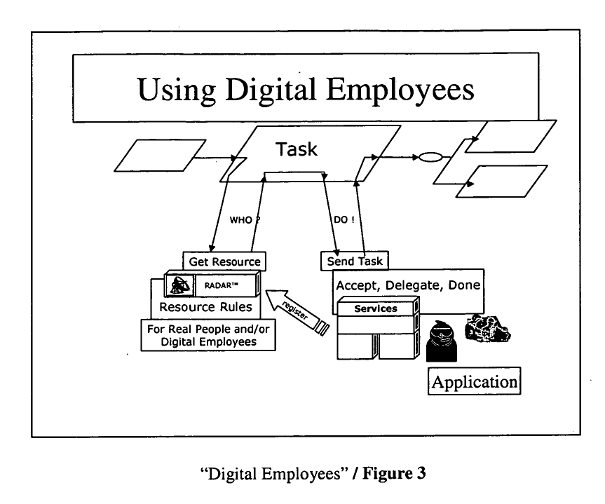

Manual: a task is assigned to a person, that person decides which software/hardware to use to perform the task and the task is completed when the person has finished such task.

Batch: a task initiates a script, such script uses software and hardware to perform the task. Scripts are hard coded implementations that statically link to the software and hardware that is used to perform such task. In this model there is no person involved into the performance of the task.

Application workflow: A task is linked to data and a specific application, the combination of such data and application is given to a person that uses that data and application to perform the task.

Digital Employees: A task is give to a Digital Employee, which decides on his own, which software and hardware to use to perform such task. This model combines the flexibility of the manual model with the automation of the batch model.

FIG. 2 shows the workflow model in more details. Historically the workflow model tried to combine the batch and manual model but failed to dynamically exchange people and applications as the underlying structure provides two interfaces, one towards a person (similar to the manual model) and one towards applications (similar to the batch model). As a result, the workflow model is an extension to the manual and batch model but does not combine the benefits of both into a single model.

FIG. 3 shows the Digital Employees model that breaks a task into two steps—first on the left a resource is assigned (resource being a person or an application)—second the task is given to that resource. Such resource performs the task and reports the result back. With that model, resources (person and applications) become interchangeable at the task level and the task does not have to know about the type of resource that is used during runtime giving the model the ultimate flexibility.

### DETAIL IMPLEMENTATION

In one aspect, the present invention fulfills the above described needs in the art by providing a method and system for automating the use of software comprising the steps of:
1. Automating the monitoring and management of systems, hardware, software and network infrastructure.
2. Automating the management of ERP systems.
3. Automating financial accounting including tax rates and tax configurations in an ERP business' accounting system
4. Reconciling various data elements from existing applications
5. Processing loan applications, inventory movements, financial transactions, electronic payments and other procedures that span multiple software packages.

In another aspect a method for setting up a schedule to perform the steps in the method above continuously and automatically according to said schedule.

This invention fulfills the above-described needs in the art by providing a method for monitoring online and in real-time the steps in the method above as performed according to the previous schedule.

In addition, this invention further fulfills the above-described needs in the art by providing a method for storing and retrieving the monitoring compliance data.

In a certain embodiment of this invention, the above method further comprises steps for setting up rules to identify exceptions when the steps in the above method are performed according to the previous schedule and monitored, using data stored and retrieved according to the description above.

In another embodiment of this invention, a system is provided for communicating exceptions to initiate human intervention.

The foregoing has outlined the general aspects of the invention and is to serve as an aid to better understand the more complete detailed description, which is to follow. In reference to such, there is to be a clear understanding that the present invention is not limited to the method or detail of deployment, software, hardware, or application of use described and illustrated herein. Any other variation of deployment, use, or application should be considered apparent as an alternative embodiment of the present invention.

We claim:

1. A method of apparatus (called “Digital Employees”) for using software, which uses such software automatically and without user interaction the same way people would use such software otherwise.

2. The method of claim 1 wherein said software is used on a plural computing environment.

3. The method of claim 1 wherein said software is used on a network connecting computers.

4. The method of claim 1 wherein said software is used on the internet.

5. The method of claim 1 wherein said software processes tasks by FIRST allocating a resource, allowing such resource to select the application to be used.

6. A method for specifying the tasks to be performed by Digital Employees in an extentable markup language XML style Language (Process Transition Markup Language) to allow them to use the other software appropriately.

7. The method of claim 6 wherein said software is used appropriately by providing a system of Digital Employees.

8. The method of claim 6 wherein said software is used appropriately by providing a mechanism to manage and monitor the performance of these Digital Employees.

9. The method of claim 6 wherein said software is used appropriately by allowing Digital Employees to enter data into other software.

10. The method of claim 6 wherein said software is used appropriately by allowing Digital Employees to read output from the other software.

11. The method of claim 6 wherein said software is used appropriately by allowing Digital Employees to execute software modules and components.

12. The method of claim 6 wherein said software is used appropriately by allowing Digital Employees to securely communicate with the other software.

13. A method for a dashboard of real-time information on the performance of Digital Employees.

14. The method of claim 13 wherein said dashboard is used for showing the status of each process in the system.

15. The method of claim 13 wherein said software is used for showing the status of each task in the system.

16. The method of claim 13 wherein said software is used for showing the resource/Digital Employee allocated to each task.

17. The method of claim 13 wherein said software is used for showing the application/software/hardware used by such Digital Employee for such task.

18. The method of claim 13 wherein said software is used for showing the time and duration of such task.

19. The method of claim 13 wherein said software is used for showing the result of such task.

20. The method of claim 13 wherein said software is used for showing other related information to such task including but not limited to cost, time, resource utilization, error codes, escalations, manual interventions.
